(19) United States
(12) Patent Application Publication
(10) Pub. No.: US 2026/0126461 A1
(43) Pub. Date: May 7, 2026

(54) Laboratory Analyser Unit

(71) Applicant: HACH LANGE GMBH, Berlin (DE)

(72) Inventors: Carsten Schulz, Berlin (DE); Clemens Hanschke, Berlin (DE); Wayne Boris Perdue, Berlin (DE)

(21) Appl. No.: 18/706,238

(22) PCT Filed: Oct. 27, 2022
(86) PCT No.: PCT/EP2022/080078

§ 371 Date: Apr. 30, 2024

(30) Foreign Application Priority Data
Nov. 4, 2021 (DE) 10 2021 128 700.6

(51) Int. Cl. G01N 35/00; G01N 35/10

(52) U.S. Cl. CPC G01N 35/00732; G01N 35/1009; G01N 2035/00752; G01N 2035/1025

(57) ABSTRACT

The invention relates to a laboratory analyser unit (10) for determining an analyte of a reagent-mixed liquid sample (48) contained in a transparent sample cuvette (40) comprising an information carrier (44) with an optical cuvette label (46), comprising an analyser (12) for determining an analyte concentration of the liquid sample (48) in the sample cuvette (40), a reading device (30) for reading the cuvette identification (46), an instrument controller (20) which, from the cuvette identification (46) read out by the reading device (30), generates a liquid sample level setpoint (SP), wherein the device control (20) comprises a liquid sample level detection (26) signal-connected to a camera (30′), which determines a liquid sample level actual value (IP) of the liquid sample (48) in the transparent sample cuvette (40) from the camera signal, and wherein a level comparison module (28) is provided which compares the determined level setpoint (SP) with the determined level actual value (IP).

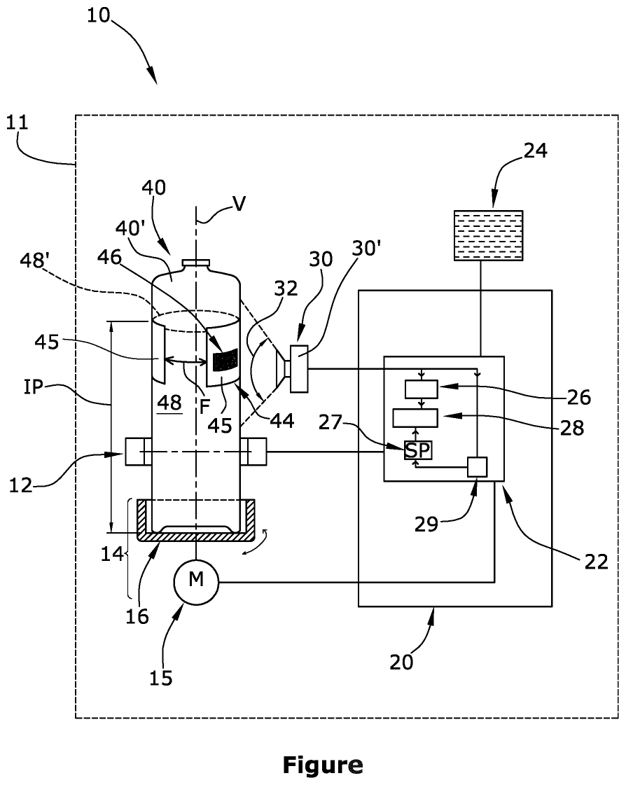

The invention refers to a laboratory analyser unit for determining a parameter or analyte of a liquid sample mixed with a reagent, the liquid sample being disposed in a transparent and cylindrical sample cuvette.

The sample cuvette is a sample container that is usually provided ready-to-use for the determination of a specific parameter or analyte of a liquid sample. The solid or liquid reagent is therefore usually already placed in the respective sample cuvette by the manufacturer, so that dosing errors of the reagent are excluded. For sample preparation, a defined volume of the liquid sample is pipetted into the cuvette already filled with the reagent. Since the ratio of the sample volume to the reagent volume is relatively small, for example less than 50, volumetric pipetting errors as so-called dilution errors can have a relevant or even considerable influence on the accuracy of the quantitative determination of the analyte that has been changed in colour by the reagent, for example, which is quantitatively determined photometrically.

From EP 3249386 A1 a photometric laboratory analyser is known which accurately determines the pipetted liquid sample volume by means of a scale integrated into the analyser unit, so that the quantitative pipetting error is subsequently converted into a corresponding correction of the liquid sample volume determined by the analyser unit photometer so that the quantitative pipetting error can then be incorporated into a corresponding correction of the raw analysis reading determined by the analyser unit photometer. This considerably improves the accuracy and reliability of the quantitative determination of the analyte in the liquid sample. However, the technical effort required for this method is considerable, since a high-precision scale with a resolution in the 2-digit milligram range is a component of the laboratory analyser unit.

Against this background, the object of the invention is to provide a simple analyser unit with a device for detecting dilution errors.

This object is solved according to the present invention by a laboratory analyser unit with the features of claim 1.

The laboratory analyser unit according to the present invention is used for determining a parameter or analyte of a liquid sample mixed and reacting with a reagent, the liquid sample being contained in a transparent and substantially cylindrical sample cuvette. In the present case, a parameter or analyte is basically any chemical or physical parameter of the liquid, for example the chemical oxygen demand, the ammonium or nitrate content or any other parameter, and in particular typical parameters of water analysis.

The sample cuvette typically comprises an information carrier with an optically readable cuvette identification. The laboratory analyser unit therefore comprises a reading device for reading the optical cuvette identification. The optical cuvette identification contains, among other things, information in coded form about the parameter or analyte that can be determined with the respective cuvette. The cuvette identification may contain further information, for example batch-specific calibration values, expiration information, etc. Such an arrangement or analyser unit is known from EP 2455761 A1.

The laboratory analyser unit further comprises a device control which indirectly or directly generates a liquid sample level setpoint on the basis of the cuvette identification read out by the reading device. This liquid sample level setpoint corresponds to a setpoint for the total liquid sample volume in the sample cuvette, i.e. the total volume of the pipetted liquid sample in which the reagent is dissolved. The liquid sample level in the sample cuvette is proportional to the total liquid volume of the pipetted liquid sample mixed with the reagent.

The liquid sample level setpoint can be obtained in many different ways. For example, for all the different and available parameters, the respective level setpoints can be stored permanently in a level setpoint memory of the laboratory analyser unit. Alternatively, the level setpoints can be downloaded online from a manufacturer's server via a corresponding digital network. Generally, it is an option to store the liquid sample level setpoint at the sample cuvette information carrier.

The device control comprises a liquid sample level detector, which is informationally connected to a camera via a signal connection, the camera pointing laterally to the sample cuvette, and which device control determines from the camera signal an actual liquid sample level value of the total liquid sample level of the whole liquid sample in the transparent sample cuvette. The liquid sample level detector comprises, for example, a simple pattern recognition system which recognises the optical characteristics of the optical refractive edge of the phase transition of the sample liquid to air visible at the wall of the cuvette, and which determines the vertical distance in relation to the camera or in relation to a zero line of the analyser unit.

The laboratory analyser unit comprises a level comparison module which compares the generated level setpoint with the actual level determined by means of the camera, and outputs a corresponding comparison signal. This signal can, for example, be a clearance signal if there is sufficient match of the actual level value with the level setpoint value, can be a corresponding correction value signal for the subsequent quantitative determination of the analyte concentration if there is a relevant but acceptable deviation, or can be a blocking signal if there is an unacceptable deviation, which blocking signal prevents the further execution and determination of an analyte concentration for the sample cuvette in question.

The camera, which is fixed to the device, is arranged in such a way in terms of height and equipped with such a wide aperture angle that all level setpoints occurring in practice always lie within the respective aperture angle of the camera. The camera can in be a vertically aligned one-dimensional line camera, but is preferably a two-dimensional plane camera.

Preferably, the reading device and the camera are identical, so that the level camera also serves as an identification reading device. The optical determination of the actual liquid sample level value and thus of the actual liquid sample volume value of the sample cuvette inserted into the laboratory analyser unit is thus carried out with the same camera that is provided anyway at the analyser unit for reading the sample cuvette information carrier. Depending on the optical quality of the camera and other boundary conditions, the determination of the actual level of the liquid sample carried out in this way is not extremely accurate, but it is in any case sufficiently accurate to be able to detect in particular serious pipetting errors without any problems, for example an accidental double pipetting or a deviation of more than a few percent from the level setpoint. In this way, the operational safety and reliability of the semi-manual quantitative determination of the analyte concentration or the parameter of the liquid sample in a laboratory analyser unit is considerably improved.

Preferably, the sample cuvette is configured to be substantially cylindrical.

Preferably, the laboratory analyser unit is equipped with a cuvette platform rotating device that rotates the cylindrical sample cuvette, which stands vertically upright on a rotary platform, about its vertical axis. The sample cuvette rotary platform is standard equipment in a typical laboratory analyser unit as well, in particular in a laboratory analyser unit that comprises as an analyser a photometer that determines the transmission or extinction horizontally and radially through the cylindrical sample cuvette at one or more specified wavelengths. During the photometry, the sample cuvette is rotated by the cuvette platform so that an average photometric transmission or absorbance value for the liquid sample in the sample cuvette can be obtained and local artefacts and local differences in the analyte concentration have no relevant negative effects.

The cuvette platform rotating device can also be used to rotate the sample cuvette information carrier with the optical cuvette identification to the front of the camera, so that the rotational alignment of the cuvette identification with the camera does not have to be done manually and/or a cuvette identification with a large surface area in the circumferential direction of the sample cuvette and a large corresponding amount of information stored therein can be read and used.

Preferably, the analyser is a photometer.

Preferably, the laboratory analyser unit comprises an optical display visually indicating a comparison result provided by the level comparison module. For example, the comparison result may be displayed numerically, for example as a percentage deviation of the actual level value from the level setpoint. The display may alternatively or additionally indicate whether the deviation of the actual level value from the level setpoint value allows or does not allow a continuation of the analysis process. Finally, the display may also indicate a correction value, if any, for the raw measured value of the analyte concentration of the liquid sample determined by the photometer or whether the respective sample cuvette should be rejected. Preferably, the laboratory analyser unit is equipped with a barcode recognition system connected to the reading device or to the camera, and the cuvette identification on the information carrier is a barcode, more preferably a two-dimensional barcode. A relatively large amount of information can be stored in a two-dimensional barcode. More preferably, the liquid sample level setpoint is also stored directly in the cuvette identification so that it is available to the laboratory analyser unit immediately after reading the cuvette identification.

Preferably, the cuvette identification is applied to an optically non-transparent label which extends over a maximum of 340° of the cylindrical circumference of the cylindrical sample cuvette. Thus, between the two vertical edges of the label, there is a transparent window extending in the vertical direction, so that in this area the liquid sample level is visible and can be detected over the entire vertical sample cuvette extension by the camera.

In the following, an embodiment of the invention is explained in more detail with reference to the drawing. The figure schematically shows an analyser unit including a sample cuvette.

The figure schematically shows a photometric laboratory analyser unit 10, with which a parameter or an analyte of a liquid sample 48 in a sample cuvette 40 is quantitatively determined. The laboratory analyser unit 10 does not comprise a scale with which the weight of the sample cuvette 40 could be determined.

The laboratory analyser unit 10 comprises, in a unit housing 11, a cuvette platform rotating device 14 comprising substantially a rotary platform 16 rotatable about a vertical axis V and a rotary platform drive motor 15, which can rotate the rotary platform 16 in one or both directions of rotation. For quantitative analyte determination, the sample cuvette 40 filled with a reagent and a liquid sample is inserted into the laboratory analyser unit 10 and placed on the cuvette rotary platform 16.

The sample cuvette 40 consists of an optically transparent and substantially hollow cylindrical glass cuvette body 40′, which is already filled with a solid reagent by the manufacturer. Sample preparation is usually carried out outside the laboratory analyser analyser unit 10 by manually pipetting a specified volume of a liquid sample into the sample cuvette 40. Typical parameters or analytes to be determined in water analysis are the chemical oxygen demand, the ammonium or the nitrate content.

The sample cuvette 40 is inserted into the laboratory analyser unit 10 for the determination of the analyte concentration so that it is placed vertically on the rotary platform. The total volume of the liquid sample 48 in the sample cuvette 40 defines the liquid sample phase boundary 48′with a liquid sample level IP vertically above the contact surface of the rotary platform 16.

On the outside, the sample cuvette 40 comprises an information carrier 44 which is a non-transparent label 45 on which an optical cuvette identification 46 is provided as a two-dimensional barcode. The label extends over approximately 330° of the cylinder circumference of the sample cuvette 40. Thus, a vertical window F with a circumferential width of approximately 30° is defined between the two vertical edges of the label 45, so that the phase boundary 48′ of the liquid sample 48 is radially visible in this region over the entire vertical extent of the sample cuvette 40.

Vertically above the rotary platform 16 and below the information carrier 44 of the inserted sample cuvette 40, the laboratory analyser unit 10 comprises a photometric analyser 12 which in the present case operates transmissively and which determines the transmission or absorption of the sample cuvette 40 filled with the liquid sample 48 at one or more specific wavelengths.

Vertically above the analyser 12, the laboratory analyser unit 10 comprises a camera 30 with a relatively large aperture angle 32. The camera 30′ generates a 2-dimensional image, thus in the present case is not a line camera, and is focused approximately at the distance to the cuvette body 40′.

The laboratory analyser unit 10 comprises an electronic and program-controlled device control 20, which is informationally connected to the cuvette platform rotating device 14, the analyser 12 and the camera 30′via corresponding signal connections. Further, the laboratory analyser unit 10 comprises a display screen 24.

The analyser control 20 includes a checking module 22 which is started after a sample cuvette 40 is inserted into the laboratory analyser unit 10 and checks whether or to what extent the actual volume of the liquid sample 48 in the sample cuvette 40 corresponds to the expected target value. For this purpose, the checking module 22 has a liquid sample level detector 26, which detects and determines an actual liquid sample level IP of the liquid sample 48 in the sample cuvette 40 from the images coming from the camera 30′ by means of a pattern recognition. For this process step, the cuvette 40 is rotated by the rotating device 14 to find and rotationally align the window F with the optical axis of the camera 30.

Further, the checking module 22 comprises a level setpoint determiner 29 which, using the cuvette identification 46 detected and identified by the camera 30′which also operates as a reading device 30, determines a level setpoint SP and stores it in a setpoint storage 27. The level setpoint SP may be included or stored in the cuvette identification 46, but may also be generated indirectly with the aid of the cuvette identification 46, for example from a level setpoint library stored in the test module 22. For reading the cuvette identification 46, the cuvette 40 is rotated by the rotating device 14 to rotationally align the cuvette identification 46 with the optical axis of the reading device 30 or camera 30′.

Finally, the checking module 22 comprises a level comparison module 28 that compares the determined level setpoint IP from the setpoint storage 27 with the associated actual liquid sample level IP from the liquid sample level detector 26. A comparison result is determined from this comparison, transmitted to and displayed on the display 24. The comparison result can be, for example, a release if the actual level value IP substantially corresponds with the level setpoint value SP, for example with a maximum deviation of 2-3 %. With a deviation of more than 20 %, a blocking signal is output as the comparison result, and the further analysis process is stopped. In the case of a deviation in between, a correction indication is output and the result of the photometric absorbance or transmittance determination determined by the analyser 12 is corrected with an adequate correction factor as soon as it is available.

An absorbance or transmittance reading is integratively determined by the analyser 12, the cuvette 40 being continuously rotated by the rotating device 14 for this purpose. The result of this raw absorbance or transmittance determination is corrected with the correction factor, if necessary, so that a corrected and more accurate absorbance or transmittance value is available, and finally an accurate concentration value for the parameter or analyte is calculated on this basis.

1-8. (canceled)

9. A laboratory analyser unit for determining an analyte of a reagent-mixed liquid sample disposed in a transparent sample cuvette comprising an information carrier with an optical cuvette identification, the analyser unit comprising:
an analyser for determining an analyte concentration of the liquid sample in the sample cuvette;
a reading device for reading the cuvette identification; and
a device control which, from the cuvette identification read out by the reading device, generates a liquid sample level setpoint;
wherein the device control comprises a liquid sample level detector signal-connected to a camera, which device control determines an actual liquid sample level value of the liquid sample in the sample cuvette on the basis of the camera signal; and
wherein a level comparison module is provided which compares the generated liquid sample level setpoint with the determined actual liquid sample level value.

10. The laboratory analyser unit according to claim 9, wherein the sample cuvette is configured substantially cylindrically.

11. The laboratory analyser unit according to claim 9, wherein the reading device is defined by the camera.

12. The laboratory analyser unit according to claim 10, further comprising a cuvette platform rotating device which rotates the sample cuvette standing on a rotary platform about its vertical axis.

13. The laboratory analyser unit according to claim 9, wherein the analyser is a photometer.

14. The laboratory analyser unit according to claim 9, wherein a display is provided indicating a comparison result coming from the level comparison module.

15. The laboratory analyser unit according to claim 9, wherein the cuvette identification is a barcode.

16. The laboratory analyser unit according to claim 9, wherein the cuvette identification is applied to a non-transparent label extending over at most 340° of the cylinder circumference of the sample cuvette.
